(19) United States
(12) Patent Application Publication
(10) Pub. No.: US 2015/0100826 A1
(43) Pub. Date: Apr. 9, 2015

(54) FAULT DOMAINS ON MODERN HARDWARE

(71) Applicant: Microsoft Corporation, Redmond, WA (US)

(72) Inventors: Nikola Vujic, Beograd (RS); Won Suk Yoo, Irvine, CA (US); Johannes Klein, Sammamish, WA (US)

(73) Assignee: Microsoft Corporation, Redmond, WA (US)

(21) Appl. No.: 14/045,682

(22) Filed: Oct. 3, 2013

(51) Int. Cl. G06F 11/30

(52) U.S. Cl. CPC G06F 11/301
USPC 714/37

(57) ABSTRACT

Improving utilization of distributed nodes. One embodiment illustrated herein includes a method that may be practiced in a virtualized distributed computing environment including virtualized hardware. Different nodes in the computing environment may share one or more common physical hardware resources. The method includes identifying a first node. The method further includes identifying one or more physical hardware resources of the first node. The method further includes identifying an action taken on the first node. The method further includes identifying a second node. The method further includes determining that the second node does not share the one or more physical hardware resources with the first node. As a result of determining that the second node does not share the one or more physical hardware resources with the first node, the method further includes replicating the action, taken on the first node, on the second node.

### BACKGROUND

### Background and Relevant Art

Computers and computing systems have affected nearly every aspect of modern living. Computers are generally involved in work, recreation, healthcare, transportation, entertainment, household management, etc.

Further, computing system functionality can be enhanced by a computing systems ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing system.

Interconnection of computing systems has facilitated distributed computing systems, such as so-called “cloud” computing systems. In this description, “cloud computing” may be systems or resources for enabling ubiquitous, convenient, on-demand network access to a shared pool of configurable computing resources (e.g., networks, servers, storage, applications, services, etc.) that can be provisioned and released with reduced management effort or service provider interaction. A cloud model can be composed of various characteristics (e.g., on-demand self-service, broad network access, resource pooling, rapid elasticity, measured service, etc), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Cloud and remote based service applications are prevalent. Such applications are hosted on public and private remote systems such as clouds and usually offer a set of web based services for communicating back and forth with clients.

Commodity distributed, high-performance computing and big data clusters comprise a collection of server nodes that house both the compute hardware resources (CPU, RAM, Network) as well as local storage (hard disk drives and solid state disks) and together, compute and storage, constitute a fault domain. In particular, a fault domain is a scope of a single point of failure. For example, a computer plugged into an electrical outlet has a single point of failure in that if the power is cut to the electrical outlet, the computer will fail (assuming that there is no back-up power source). Non-commodity distributed clusters can be configured in a way that compute servers and storage are separate. In fact they may no longer be in a one-to-one relationship (i.e., one server and one storage unit), but many-to-one relationships (i.e., two or more servers accessing one storage unit) or many to many relationships (i.e., two or more servers accessing two or more storage units). In addition, the use of virtualization on a modern cluster topology with storage separate from compute adds complexities to the definition of a fault domain, which may need to be defined to design and build a highly available solution, especially as it concerns data replication and resiliency.

Existing commodity cluster designs have made certain assumptions that the physical boundary of a server (and its local storage) defines the fault domain. For example, a workload service (i.e. software), CPU, memory and storage are all within the same physical boundary which defines the fault domain. However, this assumption is not true with virtualization since there can be multiple instances of the workload service and on a modern hardware topology, the compute (CPU/memory) and the storage are not in the same physical boundary. For example, the storage may be in a separate physical boundary, such as storage area network (SAN), network attached storage (NAS), just a bunch of drives (JBOD), etc).

Applying such designs to a virtualized environment on the modern hardware topology is limiting and does not offer the granular fault domains to provide a highly available and fault tolerant system.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method that may be practiced in a virtualized distributed computing environment including virtualized hardware. Different nodes in the computing environment may share one or more common physical hardware resources. The method includes acts for improving utilization of distributed nodes. The method includes identifying a first node. The method further includes identifying one or more physical hardware resources of the first node. The method further includes identifying an action taken on the first node. The method further includes identifying a second node. The method further includes determining that the second node does not share the one or more physical hardware resources with the first node. As a result of determining that the second node does not share the one or more physical hardware resources with the first node, the method further includes replicating the action, taken on the first node, on the second node.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example of fault domains;

FIG. 2 illustrates a modern hardware implementation;

FIG. 3 illustrates node grouping using modern hardware;

FIG. 4 illustrates node grouping using modern hardware;

FIG. 5 illustrates node grouping using modern hardware with a single node group;

FIG. 6 illustrates node grouping using modern hardware with placement constraints applied to place replicas in different fault domains;

FIG. 7 illustrates node grouping using modern hardware with placement constraints applied to place replicas in different fault domains;

FIG. 8 illustrates service request replication;

FIG. 9 illustrates request replication using hardware constraints when virtual application server may be implemented on the same hardware;

FIG. 10 illustrates a method of improving utilization of distributed nodes; and

FIG. 11 illustrates a sequence diagram showing replication placement process using hardware constraints.

### DETAILED DESCRIPTION

Embodiments described herein may include functionality for facilitating definitions of granular dependencies within a hardware topology and constraints to enable the definition of a fault domain. Embodiments may provide functionality for managing dependencies within a hardware topology to distribute tasks to increase high availability and fault tolerance. A given task in question can be any job that needs to be distributed. For example, one such task may include load balancing HTTP requests across a farm of web servers. Alternatively or additionally such a task may include saving/replicating data across multiple storage servers. Embodiments extend and provide additional dependencies introduced by virtualization and modern hardware topologies to improve distribution algorithms to provide high availability and fault tolerance.

Embodiments may supplement additional constraints between virtual and physical layers to provide a highly available and fault tolerant system. Additionally or alternatively, embodiments redefine and augment fault domains on a modern hardware topology as the hardware components no longer share the same physical boundaries. Additionally or alternatively, embodiments provide additional dependencies introduced by virtualization and modern hardware topology so that the distribution algorithm can be optimized for improved availability and fault tolerance.

By providing a more intelligent request distribution algorithm, the result with the fastest response time (in the case of load balancing HTTP requests) is returned, resulting in a better response time.

By providing a more intelligent data distribution algorithm, over-replication (in the case of saving replicated data) can be avoided, resulting in better utilization of hardware resources and high data availability is achieved by reducing failure dependencies.

In this way failure domain boundaries can be established on modern hardware. This can help an action succeed in the face of one or more failures, such as hardware failures, messages being lost, etc. This can also be used to increase the number of customers being serviced.

The following now illustrates how a distributed application framework might distribute replicated data across data nodes. In particular, the Apache Hadoop framework available from The Apache Software Foundation may function as described in the following illustration of a cluster deployment on a modern hardware topology.

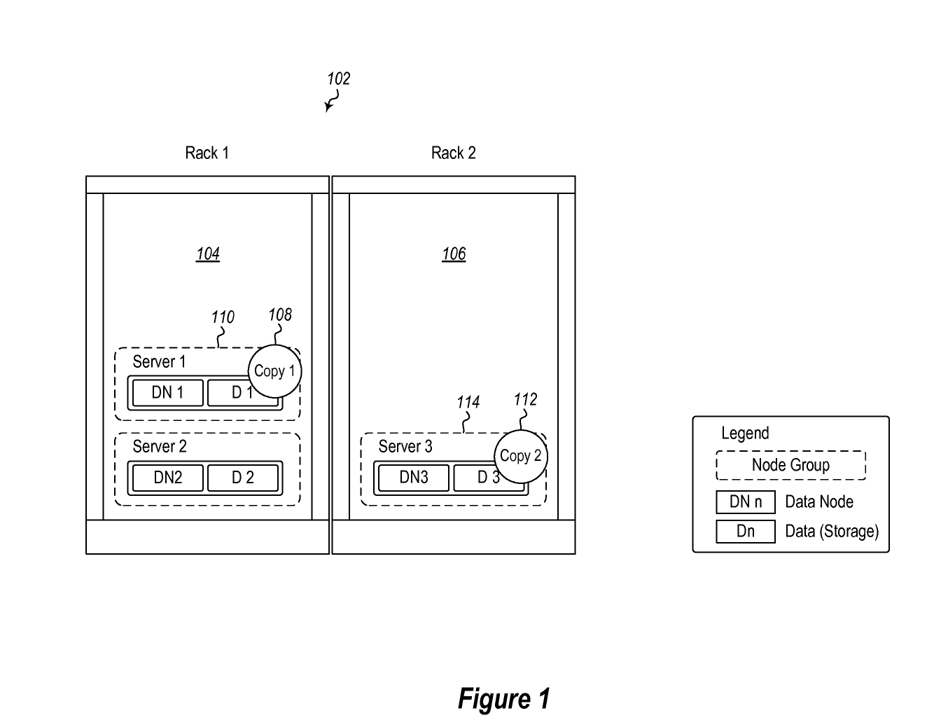

A distributed application framework, such as Apache Hadoop provides data resiliency by making several copies of the same data. In this approach, how distributed application framework distributes the replicated data is important for data resiliency because if all replicated copies are on one disk, the loss of the disk would result in losing the data. To mitigate this risk, a distributed application framework may implement a rack awareness and node group concept to sufficiently distribute the replicated copies in different fault domains, so that a loss of a fault domain will not result in losing all replicated copies. As used herein, a node group is a collection of nodes, including compute nodes and storage nodes. A node group acts as a single entity. Data or actions can be replicated across different node groups to provide resiliency. For example consider the example illustrated in FIG. 1. FIG. 1 illustrates a distributed system 102 including a first rack 104 and a second rack 106. In this example, by leveraging the rack awareness and node group, the distributed application framework has determined that storing one copy 108 on Server 1 110 and the other copy 112 on Server 3 114 (replication factor of 2) is the most fault tolerant way to distribute and store the two (2) copies of the data. In this case:

If Rack 1 104 goes off-line, Copy 2 112 is still on-line.

If Rack 2 106 goes off-line, Copy 1 108 is still on-line.

If Server 1 110 goes off-line, Copy 2 112 is still on-line.

If Sever 3 114 goes off-line, Copy 1 108 is still on-line.

This works well, when the physical server contains a distributed application framework service (data node), compute (CPU), memory and storage. However, when virtualization is used on modern hardware, where the components are not in the same physical boundary, there are limitations to this approach.

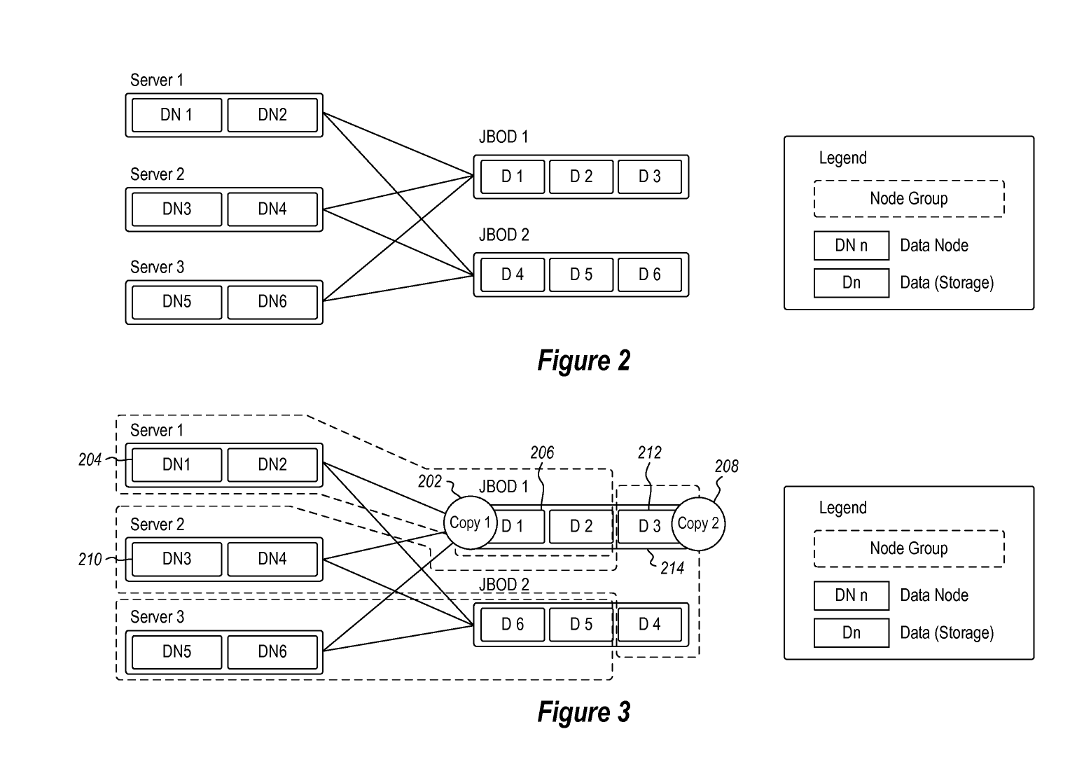

For example, consider a similar deployment, illustrated in FIG. 2 where both virtualization and separate storage are used. Using virtualization, two data nodes are hosted on one physical server. Using a separate storage (JBOD), the compute (CPU) and storage are on two physical boundaries. In this case, there is no optimal way to define the node group and main data resiliency due to the asymmetrical mapping between compute (CPU) and storage that have been introduced by the use of virtualization on a modern hardware. Consider the following three options.

Option 1: Node group per server. FIG. 3 illustrates an example where a node group per physical server is implemented. The limitations of this option is that with a replication factor of 2, if Copy 1 202 is stored by data node DN1 204 at disk D1 206, and Copy 2 208 is stored by data node DN3 210 at disk D3 212, then the loss of JBOD1 214 would result in data loss. Alternatively, a replication factor of 3 could be used, resulting in smaller net available storage space. Although a replication factor of 3 will avoid data loss (losing all three copies), unexpected replica loss cannot be avoided as a single failure will cause loss of two replicas.

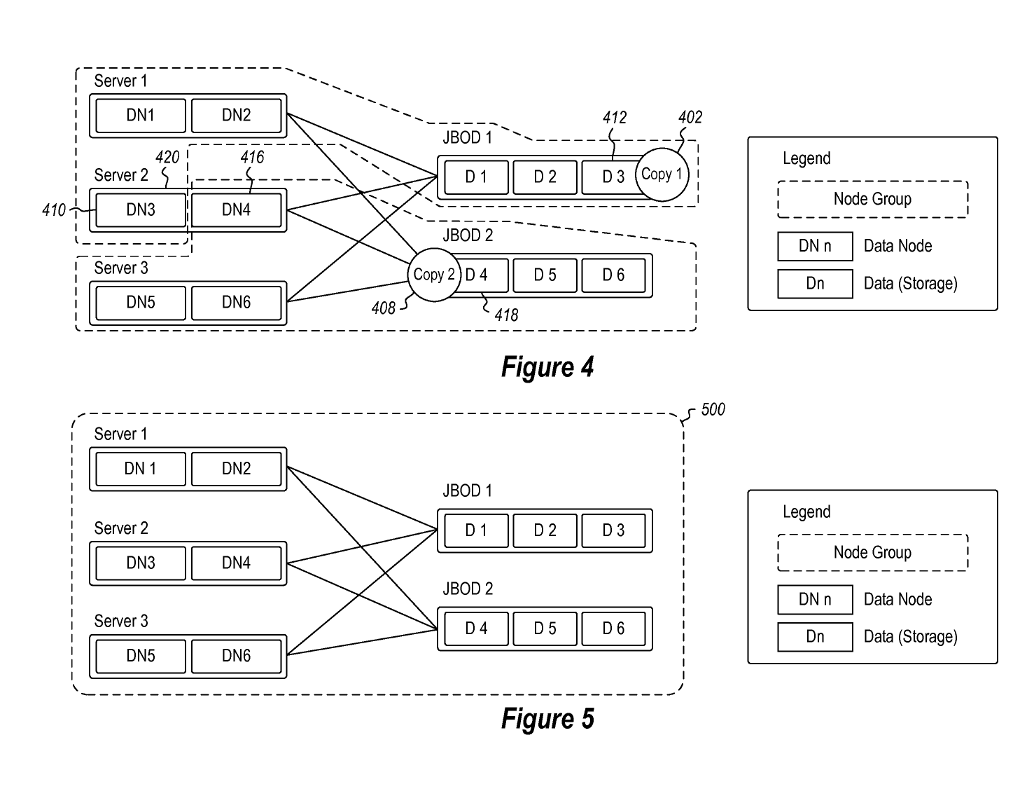

Option 2: Node group per JBOD. FIG. 4 illustrates an example where a node group per JBOD is implemented. The limitation of this option is that with a replication factor of 2, if Copy 1 402 is stored by data node DN3 410 at disk D3 412 and Copy 2 408 is stored by data node DN4 416 at disk D4 418, then the loss of physical server 2 420 would result in data loss.

Option 3: One node group. FIG. 5 illustrates an example where a single group node 500 is implemented. The limitation of this option is that data resiliency cannot be guaranteed regardless of how many copies of the data are replicated. If this node group configuration is used, then the only option is to deploy additional servers to create additional node groups which would be 1) expensive and 2) arbitrarily increase the deployment scale regardless of the actual storage need.

Embodiments herein overcome these issues by leveraging both the rack awareness and the node group concept and extend them to introduce a dependency concept within the hardware topology. By further articulating the constraints in the hardware topology, the system can be more intelligent about how to distribute replicated copies. Reconsider the examples above:

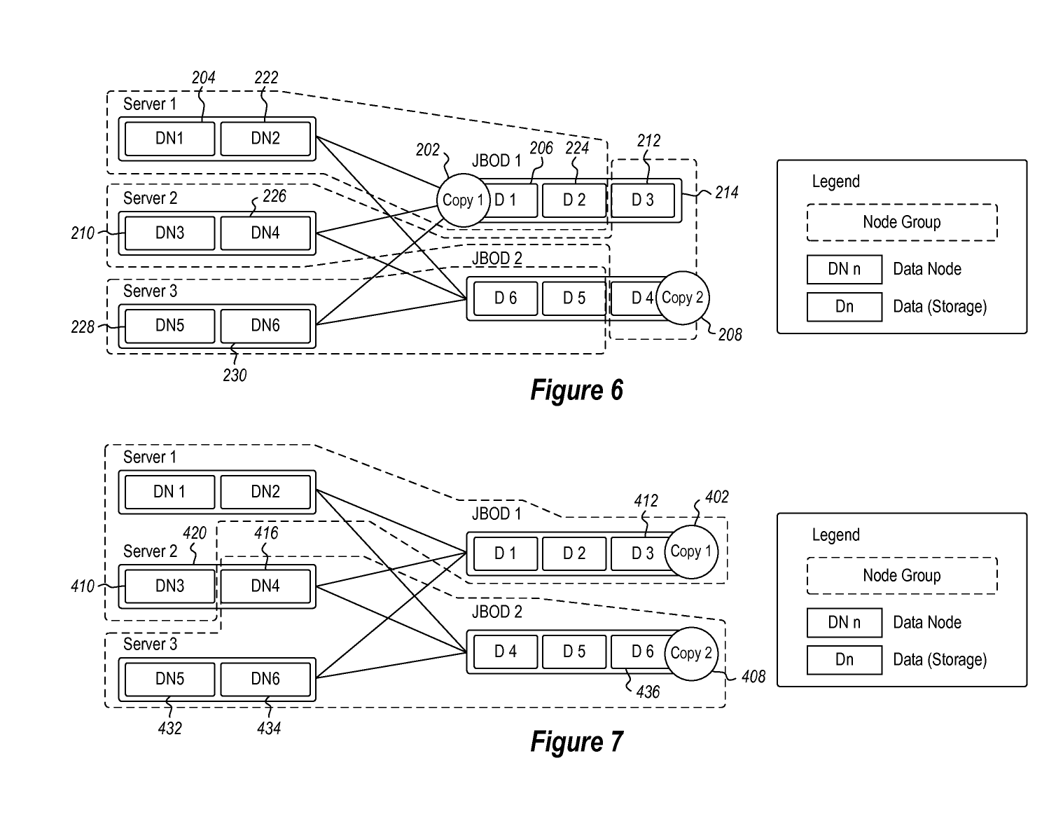

Option 1: Node group per Server. FIG. 6 illustrates the node group configuration illustrated in FIG. 3, but with constraints limiting where data copies can be stored. In this example, embodiments define a constraint between data node DN1 204, data node DN2 222 and data node DN3 210 because the corresponding storage, disk D1 206, disk D2 224 and disk D3 212 are in the same JBOD 214. If Copy 1 202 is stored in data node DN1 204, then by honoring the node group, Copy 2 208 can be stored in data node DN3 210, data node DN4 226, data node DN5 228 or data node DN6 230. However, data node DN2 222 and data node DN3 210 are not suitable for Copy 2 208 due to the additional constraint that has been specified for this hardware topology, namely that different copies cannot be stored on the same JBOD. Therefore, one of data node DN4 226, data node DN5 228 or data node DN6 230 is used for Copy 2 208. In example illustrated in FIG. 6, data node DN4 226 is picked to store Copy 2 208.

Option 2: Node group per JBOD. FIG. 7 illustrates an example with the same node group configuration as the example illustrated in FIG. 4, but with certain constraints applied. In this example, embodiments define the constraint between data node DN3 410 and data node DN4 416 because they are virtualized on the same physical server, Server 2 420. If Copy 1 402 can be stored in data node DN3 410 by storing in disk D3 412, then honoring the node group, Copy 2 is stored in one of data node DN4 416, data node DN5 432 or data node DN6 434. However, data node DN4 416 is not suitable for Copy 2 408 due to the additional constraint that has been specified for this hardware topology, namely that copies cannot be stored by data nodes that share the same physical server. Therefore, either data node DN5 432 or data node DN6 434 must be used for Copy 2 408. In the example, illustrated in FIG. 7, data node DN6 434 is picked to store Copy 2 408.

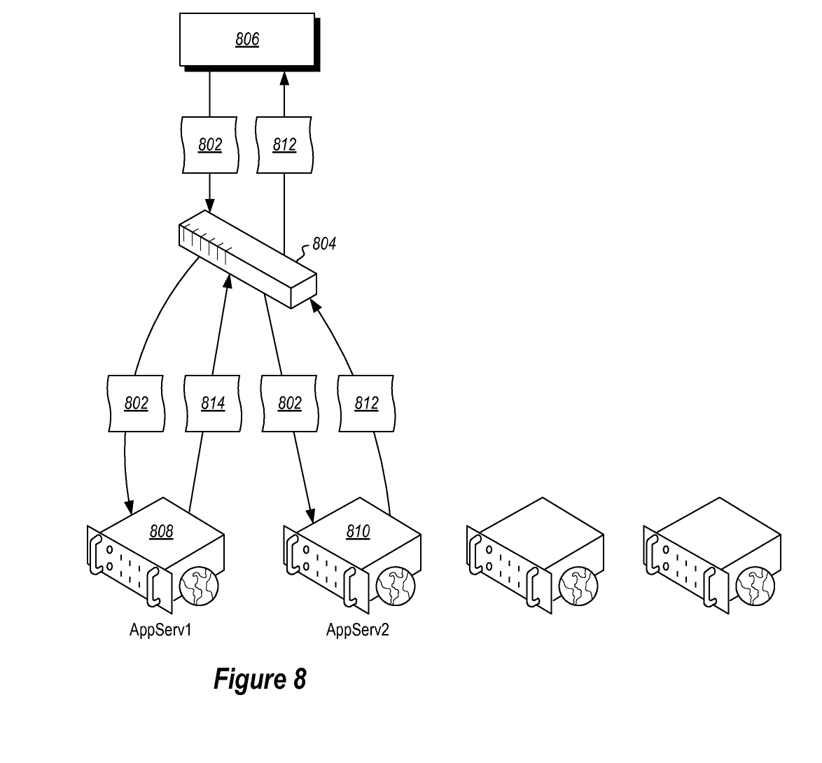

As noted above, specifying additional hardware and deployment topology constraints can also be used to intelligently distribute web requests. For example, as a way to optimize the user response time, a load balancer may replicate web requests and forward them to multiple application servers. The load balancer sends the response back to the client with the fastest response from any application server and will discard the remaining responses. For example, with reference now to FIG. 8, a request 802 is received at a load balancer 804 from a client 806. The request is replicated by the load balancer 804 and sent to application servers 808 and 810. In this example, AppSrv2 810 responds first and the load balancer 804 forwards the response 812 to client 806. AppSrv1 808 responds slower and the response is discarded by the load balancer.

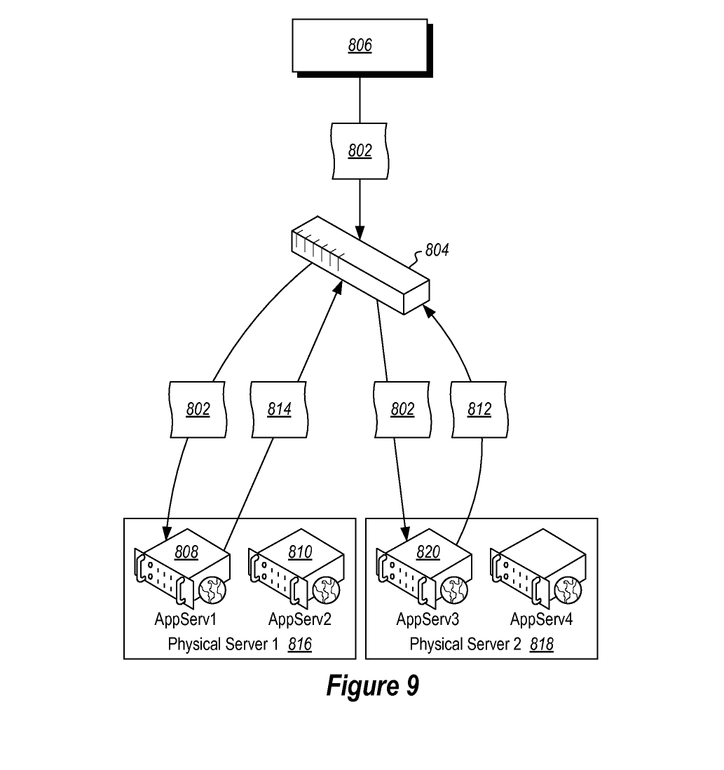

However, if as illustrated in FIG. 9, the load balancer 804 has additional awareness that AppSrv1 808 and AppSrv2 810 are virtualized but hosted on the same physical server 816, then embodiments can replicate and send the requests to AppSrv1 808 and AppSrv3 820 on physical server 818 given that there is an increased probability of receiving a different response time from an application server that does not share any resources with AppSrv1 808. In particular, if the request 802 were replicated and sent to AppSrv1 808 and AppSrv2 810 in FIG. 9 when both are on the same physical server 816, the responses 812 and 814 would likely be very similar and thus little or no advantage would be obtained by replicating the request 802. However when the request is replicated and sent to AppSrv1 808 on physical server 1 816 and AppSrv3 820 on physical server 818, in the aggregate response time can be reduced as the different application servers on different physical servers will likely have significantly different response times.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

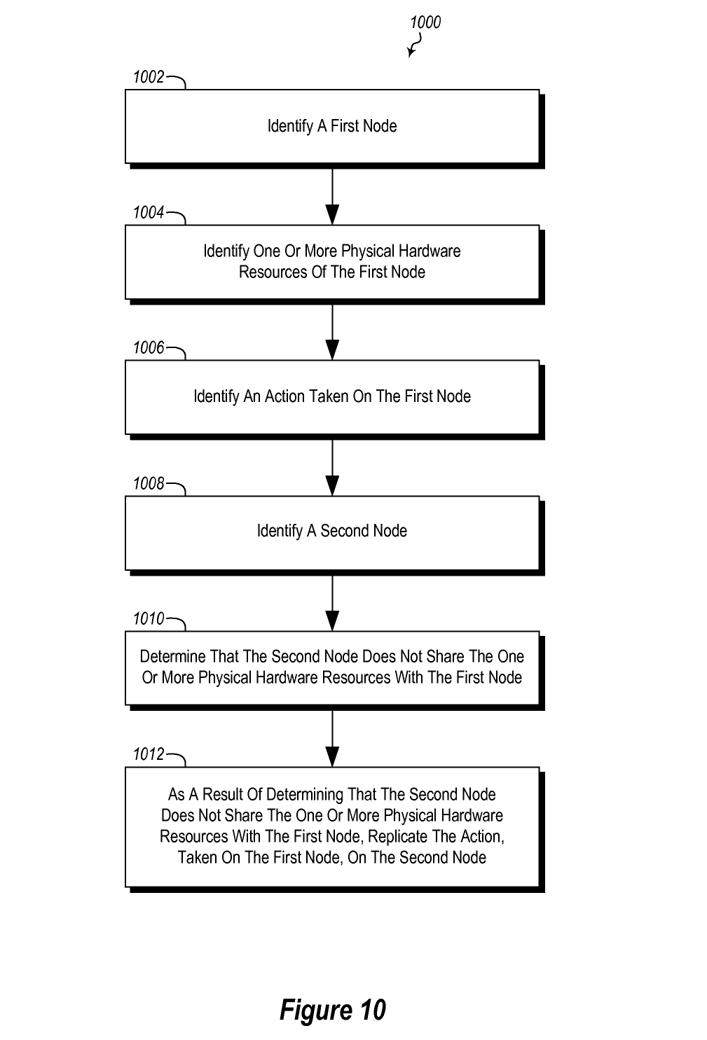

Referring now to FIG. 10, a method 1000 is illustrated. The method 1000 may be practiced in a virtualized distributed computing environment including virtualized hardware. In particular, different nodes in the computing environment may share one or more common physical hardware resources. The method includes acts for improving utilization of distributed nodes. The method includes identifying a first node (act 1002). For example, as illustrated in FIG. 7, a data node DN3 410 may be identified.

The method 1000 further includes identifying one or more physical hardware resources of the first node (act 1004). For example, as illustrated in FIG. 7, the physical server 2 420 is identified as being a physical hardware resource for implementing the node DN3 410.

The method 1000 further includes identifying an action taken on the first node (act 1006). In the example illustrated in FIG. 7, the action identified may be the placement of Copy 1 on the node DN3 410 at the disk D3 412.

The method 1000 further includes identifying a second node (act 1008). In the example illustrated in FIG. 7, data node DN6 434 is identified.

The method 1000 further includes determining that the second node does not share the one or more physical hardware resources with the first node (act 1010). In the example illustrated in FIG. 7, this is done by having a constraint applied to node DN3 410 and DN4 416 as a result of these nodes being implemented on the same physical server 420. Thus, because there is no constraint with regard to DN6 434 with respect to DN3 410, it can be determined that DN3 410 and DN6 434 do not share the same physical server.

As a result of determining that the second node does not share the one or more physical hardware resources with the first node, the method 1000 further includes replicating the action, taken on the first node, on the second node (act 1012). Thus, for example, as illustrated in FIG. 7, Copy 2 408 is placed on the node DN6 434 by placing Copy 2 408 on the disk D6 434.

As illustrated in FIG. 7, the method 1000 may be practiced where replicating the action, taken on the first node, on the second node includes replicating a resource object. However, other alternatives may be implemented.

For example, the method 1000 may be practiced where replicating the action, taken on the first node, on the second node comprises replicating a service request to the second node. An example of this is illustrated in FIG. 9, which shows replicating a request 802 to an application server AppSrv 1 808 on a physical server 806 and an application server AppSrv 3 820 on a different physical server 818 such that the different application servers do not share the same physical server. This may be done for load balancing to ensure that load is balanced between different physical hardware components or for routing to ensure that routing requests are evenly distributed. Alternatively, this may be done to try to optimize response times for client service requests as illustrated in the example of FIG. 9.

For example, replicating a service request to the second node may include optimizing a response to a client sending a service request. In such an example, the method may further includes receiving a response from the second node; forwarding the response from the second node to the client sending the service request; receiving a response from the first node after receiving the response from the second node; and discarding the response from the first node. Thus, as illustrated in FIG. 9, identifying a first node includes identifying the AppSrv 1 808. Identifying one or more physical hardware resources of the first node includes identifying the physical server 1 816. Identifying an action taken on the first node includes identifying sending the request 802 to AppSrv 1 808. Identifying a second node includes identifying the AppSrv 3 820. Determining that the second node does not share the one or more physical hardware resources with the first node includes identifying that AppSrv 1 808 and AppSrv 3 820 are on different physical servers. As a result of determining that the second node does not share the one or more physical hardware resources with the first node, replicating the action, taken on the first node, on the second node includes sending the request 802 to the AppSrv 3 820. Receiving a response from the second node includes receiving the response 812 from AppSrv 3 820. Forwarding the response from the second node to the client sending the service request includes the load balancer 804 forwarding the response 812 to the client 806. Receiving a response from the first node after receiving the response from the second node includes receiving the response 814 from the AppSrv 1 808. Discarding the response from the first node includes discarding the response 814 at the load balancer 804.

The method 1000 may be practiced where determining that the second node does not share the one or more physical hardware resources with the first node includes determining that the second node does not share physical hardware processor resources with the first node. Alternatively or additionally, determining that the second node does not share the one or more physical hardware resources with the first node includes determining that the second node does not share physical hardware memory resources with the first node. Alternatively or additionally, determining that the second node does not share the one or more physical hardware resources with the first node includes determining that the second node does not share physical hardware storage resources with the first node. Alternatively or additionally, determining that the second node does not share the one or more physical hardware resources with the first node includes determining that the second node does not share physical hardware network resources with the first node. Alternatively or additionally, determining that the second node does not share the one or more physical hardware resources with the first node includes determining that the second node does not share a host with the first node. Alternatively or additionally, determining that the second node does not share the one or more physical hardware resources with the first node includes determining that the second node does not share a disk with the first node. Alternatively or additionally, determining that the second node does not share the one or more physical hardware resources with the first node includes determining that the second node does not share a JBOD with the first node. Alternatively or additionally, determining that the second node does not share the one or more physical hardware resources with the first node includes determining that the second node does not share a power source with the first node. Etc.

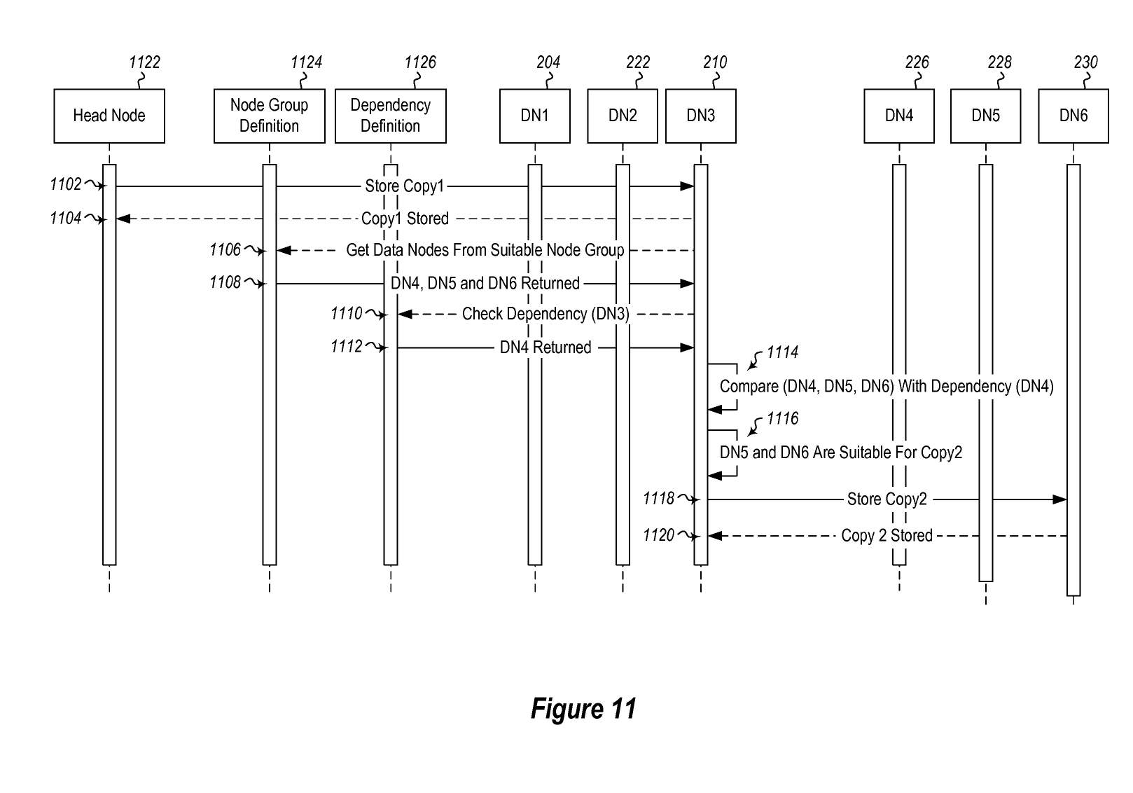

Referring now to FIG. 11, a replication placement process is illustrated. The results of this placement are shown in FIG. 7 above. At 1102, a head node 1122 indicates that Copy 1 of a resource is to be stored on data node DN3 210. At 1104, the data node DN3 210 indicates that the Copy 1 was successfully stored.

At 1106, the data node DN3 210 requests from the node group definition 1124 of list of other nodes that are in a different node group than the data node DN3 210. The node group definition 1124 returns an indication to the data node DN3 that nodes DN4 226, DN5, 228 and DN6 230 are in a different node group than node DN3 210.

The data node DN3 210 then consults a dependency definition 1126 to determine if any nodes share a dependency with the data node DN3 210. In particular, the dependency definitions can define data nodes that should not have replicated actions performed on them as there may be some shared hardware between the nodes. In this particular example, nodes DN3 210 and DN4 226 reside on the same physical server and thus the dependency definition returns an indication that node DN4 226 shares a dependency with node DN3 210.

As illustrated at 1114, the data node DN3 210 compares the returned dependency (i.e. data node DN4 226) with the node group definition that includes nodes DN4 226, DN5 228 and DN6 230. The comparison causes the node DN3 to determine that DN5 228 and DN6 230 are suitable for Copy 2.

Thus, at 1118, the node DN3 210 indicates to node DN6 230 that Copy 2 should be stored at the node DN6 230. The node DN6 230 stores the Copy 2 at the node DN6 230 and sends an acknowledgement back to the node DN3 210 as illustrated at 1120.

Further, the methods may be practiced by a computer system including one or more processors and computer readable media such as computer memory. In particular, the computer memory may store computer executable instructions that when executed by one or more processors cause various functions to be performed, such as the acts recited in the embodiments.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. A computing system may be distributed over a network environment and may include multiple constituent computing systems.

In its most basic configuration, a computing system typically includes at least one processing unit and memory. The memory may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

As used herein, the term “executable module” or “executable component” can refer to software objects, routings, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory of the computing system. The computing system may also contain communication channels that allow the computing system to communicate with other message processors over, for example, the network.

Embodiments described herein may comprise or utilize a special-purpose or general-purpose computer system that includes computer hardware, such as, for example, one or more processors and system memory, as discussed in greater detail below. The system memory may be included within the overall memory. The system memory may also be referred to as “main memory”, and includes memory locations that are addressable by the at least one processing unit over a memory bus in which case the address location is asserted on the memory bus itself. System memory has been traditional volatile, but the principles described herein also apply in circumstances in which the system memory is partially, or even fully, non-volatile.

Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a virtualized distributed computing environment including virtualized hardware, a method of improving utilization of distributed nodes, the method comprising:
in a virtualized distributed computing environment including virtualized hardware, identifying a first node, where different nodes in the computing environment may share one or more common physical hardware resources;
identifying one or more physical hardware resources of the first node;
identifying an action taken on the first node;
identifying a second node;
determining that the second node does not share the one or more physical hardware resources with the first node;
as a result of determining that the second node does not share the one or more physical hardware resources with the first node, replicating the action, taken on the first node, on the second node.

2. The method of claim 1 wherein replicating the action, taken on the first node, on the second node comprises replicating a resource object.

3. The method of claim 1 wherein replicating the action, taken on the first node, on the second node comprises replicating a service request to the second node.

4. The method of claim 3 wherein replicating a service request to the second node comprises performing load balancing of service requests.

5. The method of claim 3 wherein replicating a service request to the second node comprises performing routing of service requests.

6. The method of claim 3 wherein replicating a service request to the second node comprises optimizing a response to a client sending a service request, the method further comprising:
receiving a response from the second node;
forwarding the response from the second node to the client sending the service request;
receiving a response from the first node after receiving the response from the second node; and
discarding the response from the first node.

7. The method of claim 1, wherein determining that the second node does not share the one or more physical hardware resources with the first node comprises determining that the second node does not share physical hardware processor resources with the first node.

8. The method of claim 1, wherein determining that the second node does not share the one or more physical hardware resources with the first node comprises determining that the second node does not share physical hardware memory resources with the first node.

9. The method of claim 1, wherein determining that the second node does not share the one or more physical hardware resources with the first node comprises determining that the second node does not share physical hardware storage resources with the first node.

10. The method of claim 1, wherein determining that the second node does not share the one or more physical hardware resources with the first node comprises determining that the second node does not share physical hardware network resources with the first node.

11. In a virtualized distributed computing environment including virtualized hardware, a system for improving utilization of distributed nodes, the system comprising
one or more processors; and
one or more computer readable media, wherein the one or more computer readable media comprise computer executable instructions that when executed by at least one of the one or more processors cause at least one of the one or more processors to perform the following:
in a virtualized distributed computing environment including virtualized hardware, identifying a first node, where different nodes in the computing environment may share one or more common physical hardware resources;
identifying one or more resources of the first node;
identifying an action taken on the first node;
identifying a second node;
determining that the second node does not share the one or more resources with the first node;
as a result of determining that the second node does not share the one or more resources with the first node, replicating the action, taken on the first node, on the second node.

12. The system of claim 11, wherein replicating the action, taken on the first node, on the second node comprises replicating a resource object.

13. The system of claim 11, wherein replicating the action, taken on the first node, on the second node comprises replicating a service request to the second node.

14. The system of claim 13, wherein replicating a service request to the second node comprises optimizing a response to a client sending a service request, the method further comprising:
receiving a response from the second node;
forwarding the response from the second node to the client sending the service request;
receiving a response from the first node after receiving the response from the second node; and
discarding the response from the first node.

15. A method used for placement of replicas for the purpose of fault tolerance in modern virtualized computing systems, the method comprising:
in a virtualized distributed computing environment including virtualized hardware identifying a first node, where different nodes in the computing environment may share one or more common physical hardware resources;
identifying one or more physical hardware resources of the first node;
identifying an object placed on the first node;
identifying a second node;
determining that the second node does not share the one or more physical hardware resources with the first node; and
as a result of determining that the second node does not share the one or more physical hardware resources with the first node, replicating the object on the second node.

16. The method of claim 15, wherein determining that the second node does not share the one or more physical hardware resources with the first node comprises determining that the second node does not share a disk with the first node.

17. The method of claim 15, wherein determining that the second node does not share the one or more physical hardware resources with the first node comprises determining that the second node does not share a host with the first node.

18. The method of claim 15, wherein determining that the second node does not share the one or more physical hardware resources with the first node comprises determining that the second node does not share memory with the first node.

19. The method of claim 15, wherein determining that the second node does not share the one or more physical hardware resources with the first node comprises determining that the second node does not share a JBOD with the first node.

20. The method of claim 15, wherein determining that the second node does not share the one or more physical hardware resources with the first node comprises determining that the second node does not share a power source with the first node.
